(19) United States
(12) Patent Application Publication
(10) Pub. No.: US 2022/0409475 A1
(43) Pub. Date: Dec. 29, 2022

(54) ADULT PLEASURE ENHANCEMENT NECK PRESSURE CUFF WITH SAFETY RELEASE

(71) Applicants: Lindsay Leanne McMURREN, Lethbridge (CA); Bradley Daniel RICHARDSON, Lethbridge (CA); Sean William BAILEY, Lethbridge (CA)

(72) Inventors: Lindsay Leanne McMURREN, Lethbridge (CA); Bradley Daniel RICHARDSON, Lethbridge (CA); Sean William BAILEY, Lethbridge (CA)

(21) Appl. No.: 17/358,233

(22) Filed: Jun. 25, 2021

(51) Int. Cl. A61H 9/00

(52) U.S. Cl. CPC A61H 9/0092; A61H 2201/0176; A61H 2201/1238; A61H 2201/1611; A61H 2201/165; A61H 2201/1654; A61H 2201/1695; A61H 2201/501; A61H 2201/5043; A61H 2201/5097; A61H 2230/208; A61H 2230/305

(57) ABSTRACT

The invention relates to an adult choke pleasure enhancement adjustable pressure cuff device. Participants can engage in solo autoerotic asphyxiation (AEA) without accidentally suffocating to death. The adjustable cuff is inflatable and sized to encompass a participant's neck and has a timed safety release function. The participant can apply the device at default setting to fit snugly, but not impede blood flow. The participant can inflate the device to the desired level of pressure that would remain at that setting at participant's discretion. They can control what happens and for how long, as long as the participant is not incapacitated. However, if at any time, the controls/settings are not engaged by the participant, the device would automatically default to zero pressure after a set time. The use of the device therefore allows a participant to safely engage in solo AEA without risking injury or death.

### FIELD OF THE INVENTION

The present invention relates generally to the field of adult choke pleasure enhancement, specifically to adjustable pressure neck cuffs, more specifically to choke neck cuffs having timed safety release functions.

### BACKGROUND

Autoerotic Asphyxiation (AEA) refers to intentionally cutting off oxygen to the brain for sexual arousal or to enhance the intensity of orgasm. It is estimated that 500 to 1000 Americans accidentally die each year as a result of partaking in solo sexual asphyxiation. As a person experiments and pushes the “safe” boundary further and further, the possibility of losing consciousness becomes greater and greater. If a person were to lose consciousness during AEA, it is extremely unlikely they'd survive due to oxygen deprivation of the brain.

The desired effect of AEA requires significant pressure to be applied to the arteries of the neck. Participants will normally use their own body weight to achieve the desired level of pressure through “controlled hanging” from an anchor point. If participants lose consciousness while hanging from an anchor point, this may result in death or brain damage. The device disclosed herein eliminates the need for a participant to hang from an anchor point to achieve the desired pressure.

If people are going to engage in AEA, there needs to be a device that minimizes or eliminates possible injury. There are numerous product that participants can buy, as described below, and more specific suffocation, bondage and choking devices available, but none of the products of devices have a built in safety feature to prevent brain damage or death.

U.S. Pat. No. 9,089,719 (Simon) discloses non-invasive methods and devices for inducing euphoria in a patient and their therapeutic application. A non-invasive magnetic stimulator is used to modulate electrical activity of a patient's vagus nerve in order to temporarily stimulate, block and/or modulate electrophysiological signals in that nerve. Parameters of the stimulation are selected in such a way as to induce a state of euphoria in the patient. The methods and devices may be used for anesthesia, or to treat insomnia, depression, or premenstrual syndromes. They may be used as substitution withdrawal tools for individuals who otherwise would depend on substances and behaviors to achieve a euphoric state of mind, particularly individuals who abusively consume drugs, alcohol or food, or who exhibit behavioral disorders such as compulsive gambling. The devices and methods may also be used to prevent, manage, or relieve stress.

CN Pat. No. 101015481 (Rongheng) discloses an adjustable elastic band to reinforce male erectile function. The device aiming at providing an adjustable elastic band which has advantages of wide applicable range, convenient wearing and enhancement of the male erectile function. The invention comprises an elastic ring which is provided with a gas bag, wherein the elastic ring is a non-closed ring-shaped structure, and the gas bag deviates from the elastic ring center and near the inside of the elastic ring. Aerating the device of the present invention is by medical hand pump, gassy or liquid in the described aerating device.

U.S. Pub. No. 2020/0351590 (Sube) discloses a music collar. The music collar is configured as a wear around the neck device, and the music collar comprises: a main frame, comprising a rear-left vibration pad and a rear-right vibration pad, configured to directly or indirectly contact the soft tissue of the back part of the neck of a person wearing the music collar; and wherein the vibration pads transform an input electrical signal to vibrations and transfer the vibrations to the soft tissue of a person wearing the music collar. The contact spots with the human body are for maximizing the feeling and pleasure and at the same time minimize the uncomfortable feeling the user gets from the vibrations produced by the vibration pads.

U.S. Pub. No. 2020/0360027 (Marcus) discloses a blood occlusion or restriction cuff. A remotely operated blood flow occlusion or restriction cuff for use as a muscle building device or a compact medical emergency reperfusion tourniquet. A module on the cuff housing an air pump, a controller operating the air pump and power supply. The inflation and deflation of the cuff controlled using a smart device in communication with the controller. In the preferred embodiment this is via a Smartphone app and Bluetooth protocol. The tourniquet operating in conjunction with a Doppler ultrasound and/or pulse oximeter to monitor arterial inflow.

U.S. Pub. No. 2017/0238825 (Fitzsimons) discloses devices and methods for measuring blood pressure. The portable blood pressure monitoring device is capable of wirelessly interacting with a secondary device, such as a cell phone, to measure blood pressure of a patient wherein the device is configurable to fold into a low profile storage configuration. The blood pressure monitoring device includes a cuff for wrapping around the limb of a subject the cuff further having an inflatable bladder formed integrally. A user has a blood pressure monitoring device comprising a blood pressure cuff and a device body secured about the arm of the user. The blood pressure monitoring device is in wireless communication with a secondary electronic device, such as a smart phone.

U.S. Pub. No. 2020/0229765 (Peabody) discloses a medical diagnostic device, system, and method of use. The mobile device is integrated in a body that is sized and shaped to be held in a palm of a hand of a user, the mobile device configured to take a plurality of physiological measurements of a patient, including electrocardiographic measurements, blood oxygen saturation level measurements, pulse rate measurements, body temperature measurements, blood pressure measurements when connected with a removable inflatable cuff, and blood glucose measurements when connected with an elongated test strip, and to display and wirelessly communicate data corresponding to said physiological measurements. The mobile device may comprise some or all of the features of an Internet enabled smartphone. The mobile device may be provided with selectable modes of operation for use with one or more patients. Wireless peripherals may provide additional physiological data to the device. Systems are provided for secure communication and storage of data.

U.S. Pat. No. 5,243,991 (Marks) discloses an adjustable blood pressure cuff and method of measuring blood pressure. A flexible blood pressure cuff for use in measuring the blood pressure of a patient, includes an inflatable bladder having a first side and a second side. One of the bladder sides is provided with hook and loop fasteners for adjustably and removably retaining at least a portion of one of the two bladder sides against a remaining portion of the one bladder side when the bladder is folded over itself. The effective inflatable width of the bladder is thereby adjusted to accommodate the circumference of the limb of the patient so that accurate blood pressure measurements may be obtained for each patient. According to the method, the blood pressure cuff is folded over itself to produce a cuff having an effective inflatable width which is adjusted according to the circumference of the limb of the patient whose blood pressure is to be measured.

U.S. Pat. No. 4,116,230 (Gorelick) discloses a blood pressure cuff automatic deflation device. The device automatically deflates a blood pressure cuff with a standard two way valve. An adjustable deflation rate consistent with normally accepted medical practice of two or three millimeters per heartbeat may be maintained. A two-state valve and associated control circuitry for maintaining a constant deflation rate are described. This allows accurate sensing of Korotkoff sounds at different pressure levels.

U.S. Pat. No. 5,467,772 (Souma) discloses an automatic sphygmomanometer. A small and power-saving automatic sphygmomanometer constructed of minimum of parts. This automatic sphygmomanometer which inflates a pressure cuff to a value higher than that of one's maximum blood pressure and measures the blood pressure in the process of deflation is comprised of a cuff, air pump connected to the cuff, constant-rate pressure reducing valve for automatically adjusting a cuff pressure reducing velocity to be constant regardless of cuff pressure, exhaust valve for exhausting the air from the cuff, and controller for controlling open/close of the exhaust valve.

U.S. Pat. No. 7,166,077 (Millay) discloses a cuff for measurement of blood pressure. The blood pressure cuff including an inflatable bladder disposed between an elastic, resilient inner layer of material and at least one outer layer of material. The bladder is secured to these layers along the elongate ends but not along the elongate edges. The bladder is not laterally constrained during inflation. The cuff is formed into a cylindrical shape having a fixed outer diameter and includes a backing layer and apparatus for securing the bladder to a layer of the cuff to hold the bladder in place during donning of the cuff. Because the bladder is not constrained along its contact-width edges, the shape of the bladder automatically adjusts to provide a longer contact surface for larger arms and a shorter contact surface for smaller arms. The cuff is especially suited for use as a closed cuff in an automated blood pressure measurement machine or in stand-alone measurement use.

All documents cited herein are incorporated by reference.

None of the above cited documents, alone or in combination satisfy the need for an AEA neck pressure cuff with safe release mechanism.

### BRIEF SUMMARY

It is an object of the invention to provide an adult pleasure enhancement neck pressure cuff with safety release.

In accordance with an aspect of the invention there is provided a neck pressure cuff with safety release device, said device comprising: a neck pressure cuff comprising an essentially rectangular sleeve of material having a front surface, a rear surface, an upper edge, a lower edge, a first side, a second side, and pair of cooperating fasteners attached to said first side and said second side; an air bladder installed in said sleeve, said air bladder attached to an inflation tube; and a combination pump and monitor unit in fluid communication with both of said air bladder and said inflation tube, said unit having a display screen and a series of controls, one of said series of controls being programmable to inflate said air bladder to a selected pressure, one of said series of controls being programmable to maintain said selected pressure for a selected time period, one of said series of controls being programmable to extend said selected time period in selected increments, one of said series of controls facilitating manual deflation of said air bladder, said unit being pre-programmed with certain safe maximum pressure levels and maximum time period for inflation, wherein, when said maximum pre-programmed safe level for pressure or maximum pre-programmed safe time period for inflation have been exceeded, or if said one of said series of controls facilitating manual deflation is activated, said unit will automatically deflate said air bladder in said pressure cuff.

In accordance with another aspect of the invention there is provided a merchandisable kit for creating a neck pressure cuff with safety release device, said kit comprising: a neck pressure cuff comprising an essentially rectangular sleeve of material having a front surface, a rear surface, an upper edge, a lower edge, a first side, a second side, and pair of cooperating fasteners attached to said first side and said second side; an air bladder installed in said sleeve, said air bladder attached to an inflation tube; a combination pump and monitor unit in fluid communication with both of said air bladder and said inflation tube, said unit having a display screen and a series of controls, one of said series of controls being programmable to inflate said air bladder to a selected pressure, one of said series of controls being programmable to maintain said selected pressure for a selected time period, one of said series of controls being programmable to extend said selected time period in selected increments, one of said series of controls facilitating manual deflation of said air bladder, said unit being pre-programmed with certain safe maximum pressure levels and maximum time period for inflation, and instructions for use, wherein, when said maximum pre-programmed safe level for pressure or maximum pre-programmed safe time period for inflation have been exceeded, or if said one of said series of controls facilitating manual deflation is activated, said unit will automatically deflate said air bladder in said pressure cuff.

In accordance with an additional aspect of the invention there is provided a device or kit, as described above, further comprising one or more rails configured to attach to said rear surface extending from said first side to said second side, and one or more pressure enhancement members adapted to attach to said one or more rails, said pressure enhancement members being selected from the group comprising: essentially circular; essentially oval; or an attachment molded into the shape of a choking hand.

In accordance with an additional aspect of the invention there is provided an additional sleeve of fabric is sized and proportioned to fit around said pressure cuff, and one or more pressure enhancement members and rails when present, said fabric optionally being customized or embellished.

The advantages and features of the present invention will become better understood with reference to the following more detailed description and claims taken in conjunction with the accompanying drawings in which like elements are identified with like symbols.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a front aspect of the subject matter in accordance with one embodiment of the invention.

FIG. 2 illustrates a rear aspect of the subject matter in accordance with one embodiment of the invention.

FIG. 3 illustrates a front aspect of the subject matter including embellishments in accordance with one embodiment of the invention.

FIG. 4 illustrates a rear aspect of the subject matter including attachment rails in accordance with one embodiment of the invention.

FIG. 5A, FIG. 5B and FIG. 5C illustrate a rear aspect of the subject matter including rails and pressure balls in accordance with one embodiment of the invention.

FIG. 6 illustrates a rear aspect of the subject matter including rails and installed pressure balls in accordance with one embodiment of the invention.

FIG. 7 illustrates an aspect of the subject matter in accordance with one embodiment.

FIG. 8 illustrates a monitor in accordance with one embodiment of the invention.

FIGS. 9A and 9B illustrate aspects of the pressure enhancement members in accordance with embodiments of the invention.

FIGS. 10A and 10B illustrate aspects of the rails in accordance with embodiments of the invention.

FIG. 11 illustrates an aspect of a pressure enhancement member in accordance with one embodiment of the invention.

FIG. 12 illustrates an aspect of a pressure enhancement sleeve in accordance with one embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The invention is an adult choke pleasure enhancement adjustable pressure cuff device. It has a timed safety release function and manual override feature. Users can engage in solo autoerotic asphyxiation (AEA) without accidentally suffocating to death. The adjustable cuff is inflatable and sized to encompass a participant's neck. The recommended operation would be to have the participant apply device at default setting to fit snugly, but not impede blood flow. The participant can inflate the device to the desired level of pressure that would remain at that setting at participant's discretion. They can control what happens and for how long, as long as the participant is not incapacitated. However, if at any time, the controls/settings are not engaged by the participant, the device would automatically default to zero pressure after a set time. The use of the device therefore allows a participant to safely engage in solo AEA without risking injury or death. The device includes a user engaged safety feature that allows the user to be able to disengage pressure at any time.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

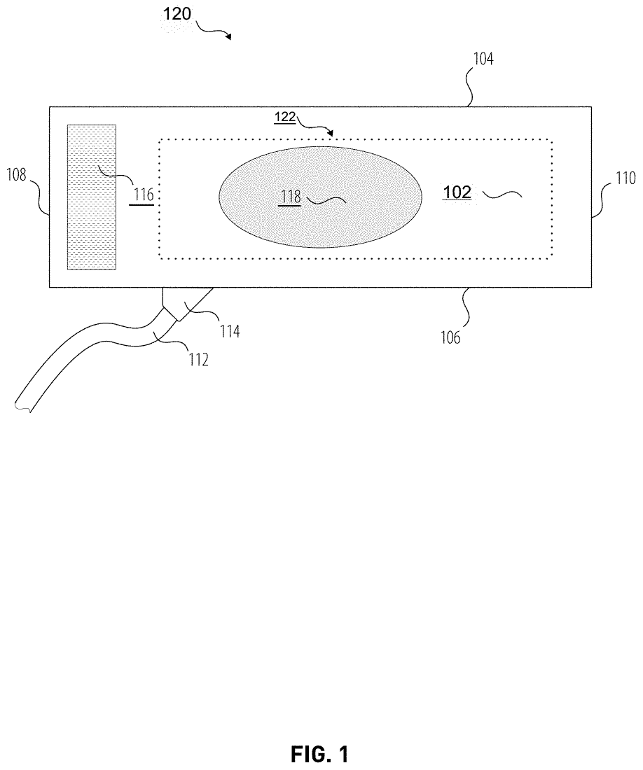

FIG. 1 shows a front surface 102 of a pressure cuff 120 in accordance with one embodiment of the invention. The pressure cuff 120 has an inflatable air bladder (not shown) linked via a connection member 114 to an inflation tube 112 that is attached to a monitor device (not shown) capable of inflating the bladder.

The pressure cuff 120 comprising an essentially rectangular tube of material having an upper edge 104, lower edge 106, first side 108 and second side 110. A hook and loop fastener 116 is positioned at the first side 108 and a decorative element 118 may be attached to the front surface 102. The decorative element 118 may be selected from the group including, but not limited to: a word; a phrase; a symbol; an image; studs; choking hand image; advertisements, etc.

The decorative element 118 or decorative elements 118 may be printed onto the front surface 102, of the pressure cuff 120 or they may be stitched or embroidered, or they may be attached by way of releasable fasteners such a snaps, poppers or hook and loop fasteners such as Velcro®. When the decorative element 118 or decorative elements 118 are attached by way of releasable fasteners, a variety of different decorative element 118 or decorative elements 118 may be used interchangeably by the participant, such as “branded” compatible patches, nameplates, unique colors, unique textures, etc., that are actually designed as attachments for this device only. The actual size of the decorative element 118 or decorative elements 118 can be of various shapes and sizes.

Certain embodiments of the invention may include selection of customized “sleeves” that would slide over top of the entire pressure cuff 120 thereby providing additional options for customized exterior colors, fabrics, and textures.

The front surface 102 of the pressure cuff 120 may be fabricated from a variety of materials selected from the group including, but not limited to: silk; satin; cotton; and polyester. The basic, non-sleeve version the front surface 102 of the pressure cuff 120 would be made from the same material as the basic cuff would be made out of. In the embodiment that features customizable separate sleeves, the front surface 102 could comprise customized exterior colors, fabrics, and textures.

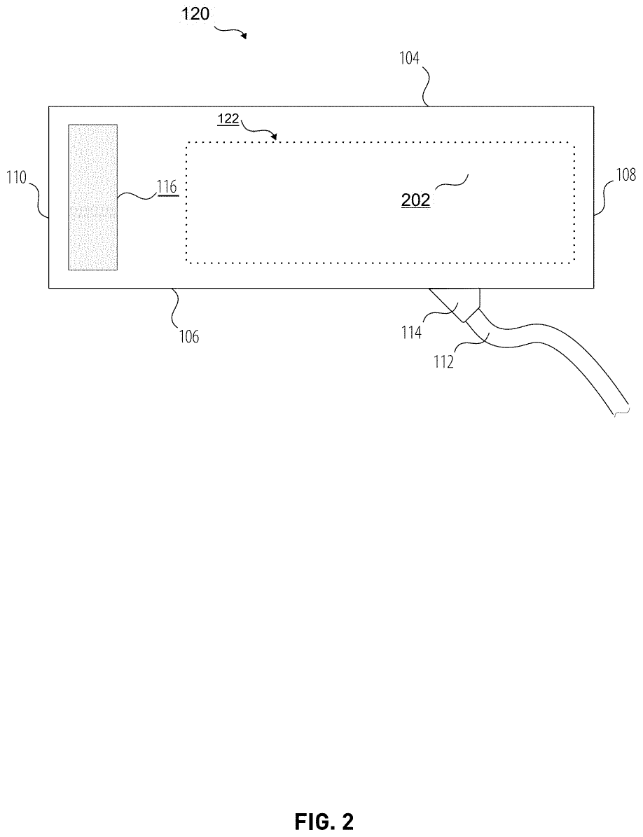

FIG. 2 shows a rear surface 202 of the pressure cuff 120 in accordance with one embodiment of the invention. Again, the inflatable air bladder, situated between the front surface 102 of the pressure cuff 120 and the rear surface 202 of the pressure cuff 120 is not shown. The connection member 114 and inflation tube 112 that are respectively attached to the inflatable air bladder and monitor device (not shown) can be seen.

The rear surface 202 of the pressure cuff 120 has an upper edge 104, lower edge 106, first side 108 and second side 110 corresponding to the upper edge 104, lower edge 106, first side 108 and second side 110 illustrated in FIG. 1. An additional piece of hook and loop fastener 116, such as Velcro®, is positioned at the second side 110 of the rear surface 202 that cooperates with the hook and loop fastener 116 attached to the first side 108 of the front surface 102.

The rear surface 202 may be fabricated from a variety of materials selected from the group including, but not limited to: silk; satin; cotton; and polyester. The basic, non-sleeve version the rear surface 202 would be made from the same material the basic cuff would be made out of. In the embodiment that features customizable separate sleeves, the rear surface 202 could comprise customized interior colors, fabrics, and textures.

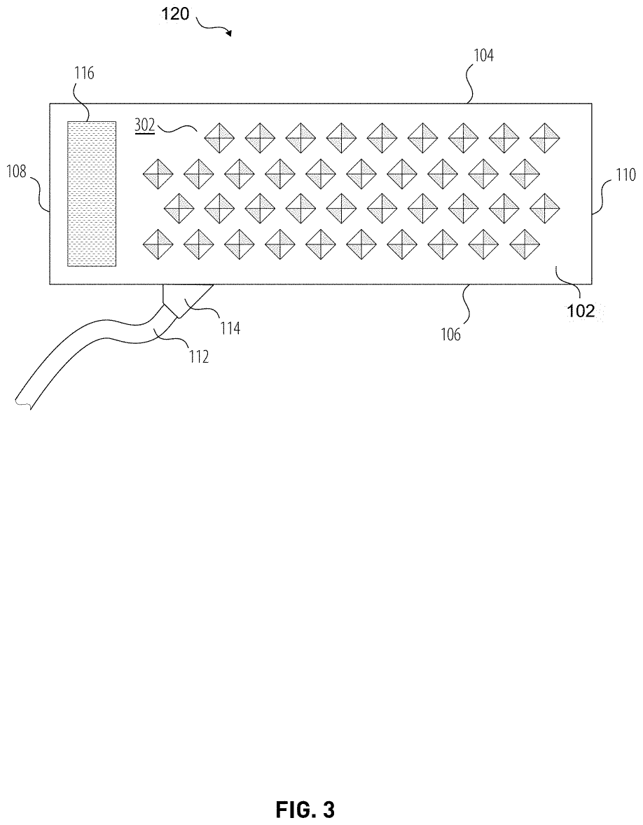

FIG. 3 shows a front surface 102 view of the pressure cuff 120 in accordance with one embodiment of the invention. The aspects illustrated in FIG. 1 can be seen, in addition to embellishments 302. In this instant the embellishments 302 are shown as studs. Various other individual embellishments 302 can be attached to the front surface 102 by, for example, gluing, sewing and riveting. Alternative embodiments of the invention may have studs on the interior of rear surface 202 of the pressure cuff 120 so the cuff squeezes the studs into the neck for additional pleasure/pain.

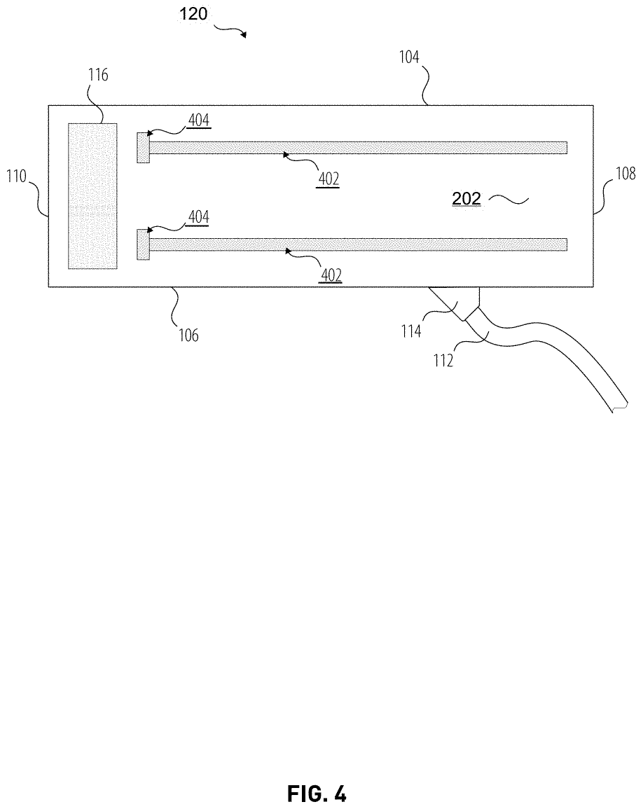

FIG. 4 shows a rear surface 202 view of the pressure cuff 120 in accordance with one embodiment of the invention. The aspects illustrated in FIG. 2 can be seen, in addition to a pair of rails 402.

Typically, the rail 402 or rails 402 additionally comprise an end stop 404. The rail 402 or rails 402 are situated on the rear surface 202 of the pressure cuff 120, and extend from the first side 108 of the pressure cuff 120 to the second side 110 of the pressure cuff 120. In the embodiment of the invention illustrated in this figure, two rails 402 with end stops 404 can be seen extending from the first side 108 to the second side 110 of the pressure cuff 120.

The rail 402 or rails 402 may be made of plastic that may be molded, extruded or 3D printed.

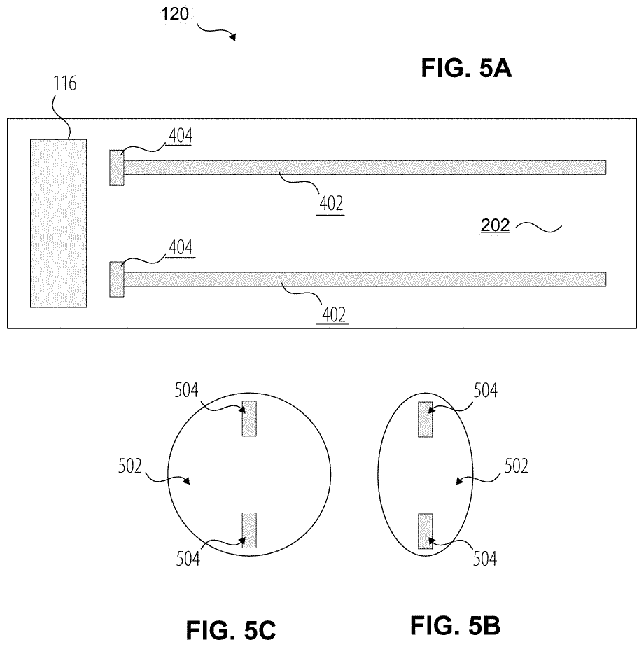

FIG. 5A shows a rear surface 202 view of the pressure cuff 120 in accordance with one embodiment of the invention. The aspects illustrated in FIG. 4 can be seen, in addition to two differently shaped pressure enhancement members 502.

Again, the rail 402 or rails 402 additionally comprise an end stop 404. The rail 402 or rails 402 are situated on the rear surface 202 of the pressure cuff 120, and extend from the first side 108 of the pressure cuff 120 to the second side 110 of the pressure cuff 120. In the embodiment of the invention illustrated in this figure, two rails 402 with end stops 404 can be seen extending from the first side 108 to the second side 110 of the pressure cuff 120.

The pressure enhancement members 502 may be oval (FIG. 5B) or circular (FIG. 5C) in shape and have a rail engagement member 504 or rail engagement members 504 attached in a position or positions such that they cooperate with the rail 402 or rails 402. Various different shaped and sized pressure enhancement members 502 are considered to be within the scope of protection sought. The purpose of the pressure enhancement members 502 is order to customize the participant's experience. The pressure enhancement members 502 add extra pressure on arteries in neck. The plastic rail 402 or rails 402 allow attachments, such as the pressure enhancement members 502 illustrated in FIGS. 5B and 5C, to slide on easily the rail 402 or rails 402 and be appropriately positioned on the neck of the participant.

Attachments will slide into the rails that are already attached to the cuff upon purchase. If a user buys a custom attachment (studs, pressure balls, etc.) simply slide the basic interior piece off, exposing the rails, then slide the attachment on, which would look like the basic interior sleeve with an attachment on it. No rails visible.

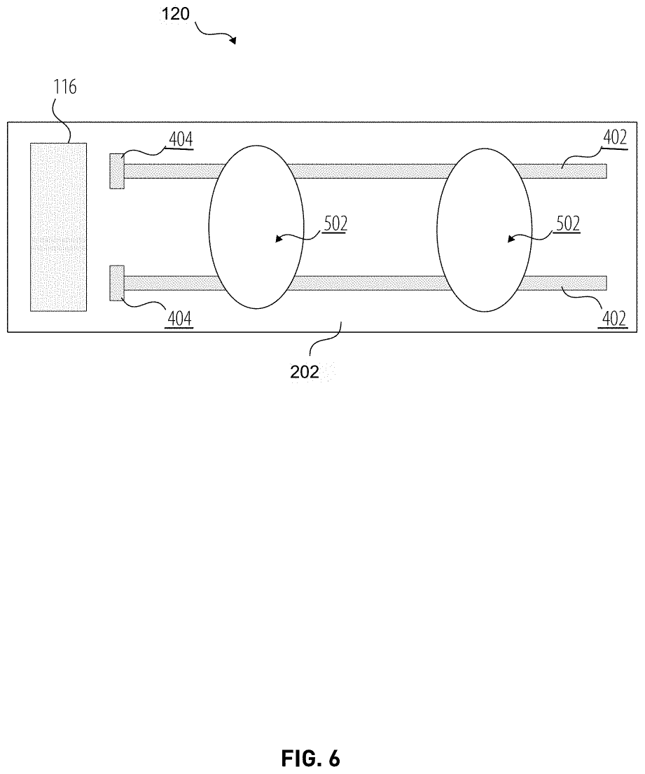

FIG. 6 shows a rear surface 202 view of the pressure cuff 120 in accordance with one embodiment of the invention. The aspects illustrated in FIG. 5 can again be seen. In this figure, the pressure enhancement members 502 can be seen installed at appropriate positions on the rails 402. The pressure enhancement members 502 may be made of plastic that is molded, extruded or 3D printed.

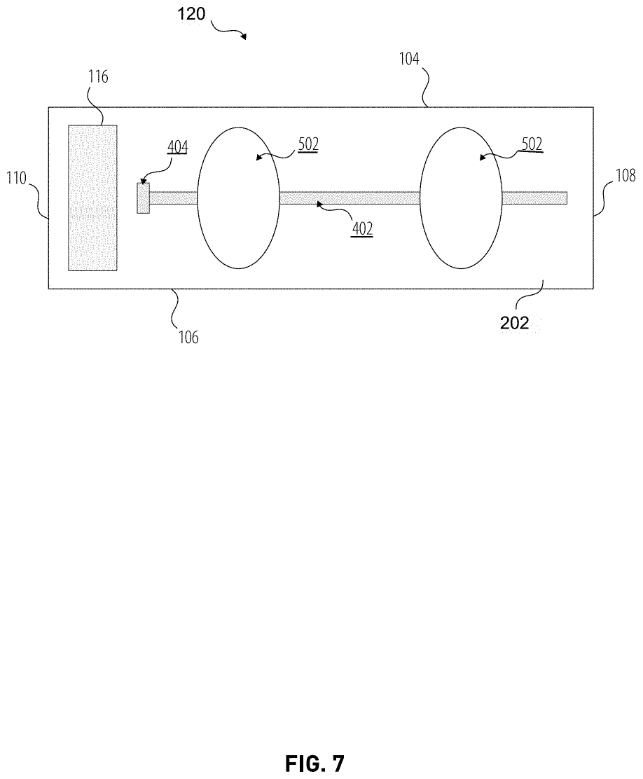

FIG. 7 shows a rear surface 202 view of the pressure cuff 120 in accordance with one embodiment of the invention. The aspects illustrated in FIG. 6 can again be seen. In this figure however, only one rail 402 is present. The rail 402 again extends from the first side 108 of the pressure cuff 120 to the second side 110 and has an end stop 404 installed. It is positioned essentially mid-way between the upper edge 104 and the lower edge 106 of the pressure cuff 120. The pressure enhancement members 502 can be seen installed at appropriate positions on the rail 402.

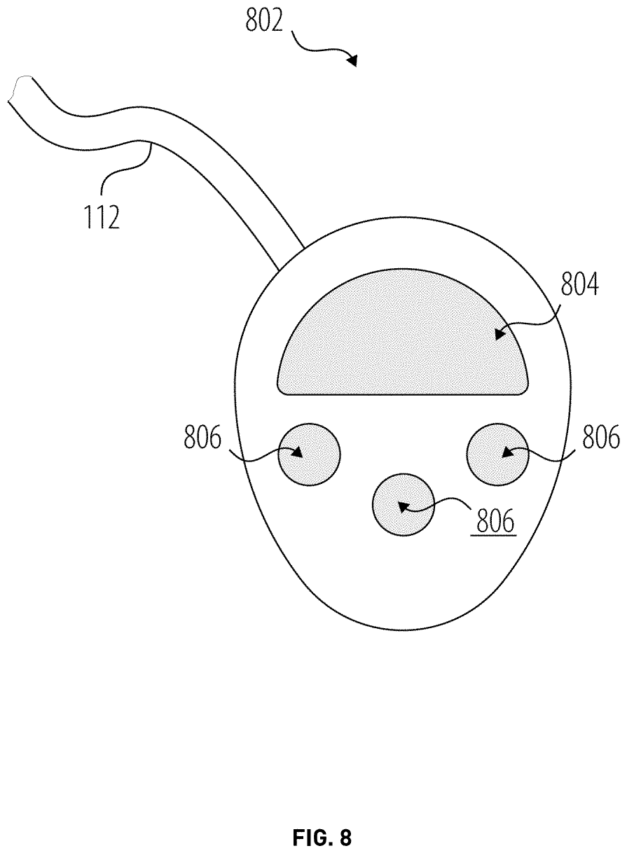

FIG. 8 shows a typical combination pump and monitor unit 802. The combination pump and monitor unit 802 features a display screen 804 and a series of control buttons 806.

The recommended mode of operation would have the participant apply the pressure cuff 120 at default setting to fit snugly around the neck, but not impede the flow of blood. The participant would set a particular time setting to maintain the pressure cuff 120 at the inflated setting. A safe maximum time period is pre-programmed into the combination pump and monitor unit 802.

The participant can then use one of the control buttons 806 to inflate air bladder inside the pressure cuff 120 to pre-selected level of pressure for the pre-selected time period. The combination pump and monitor unit 802 is pre-programmed so as not to exceed a previously determined safe maximum time limit. From the moment the cuff has been inflated to desired pressure setting, the control mechanism, should remain at that pressure setting for the participant's desired time option.

When the time is approaching for the pressure cuff 120 to deflate, a ‘countdown to zero pressure’ indicator will be deployed and the combination pump and monitor unit 802 will give a visual, light or sound indication. If the participant does not want the countdown to begin, they can re-engage the controls and an additional pre-determined time option will start commence, up to the previously determined safe maximum time limit. Typically, the second, and subsequent, re-engagement of the controls would provide a shorter inflated time interval that the previous engagement/re-engagement period.

The participant will be able to start the time option over at any time prior to the official countdown beginning. Similarly, they will be able to deflate pressure cuff 120 to zero pressure at any time. The countdown to deflation will only start if the participant has not engaged any of the override options to either extend the inflation period, or to prematurely deflate the pressure cuff 120. As long as the participant is not incapacitated, they can control what happens and for how long through the display screen 804 and pre-programmed control panel. However, if the participant becomes incapacitated and is unable to operate the safety deflate control button 806, the pressure cuff 120 will automatically deflate to zero pressure within the predetermined time period, before serious injury has occurred. Hence the participant can safely engage in autoerotic asphyxiation without risking injury or death.

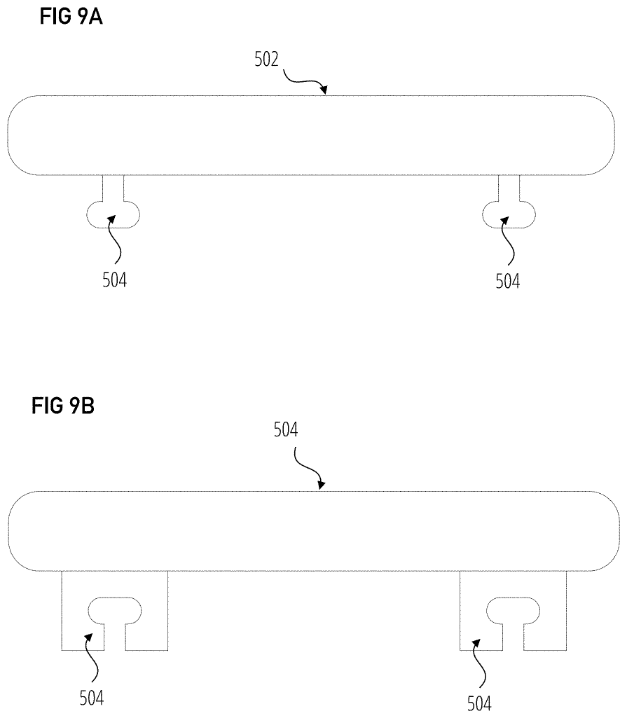

FIGS. 9A and 9B show in details of the connection mechanism of the pressure enhancement members 502 to the rails 402 (not shown).

FIG. 9A illustrates generally a pressure enhancement member 502 that is for connection to the pressure cuff 120 (not shown) by way of rail engagement members 504. In this embodiment, the rail engagement members 504 are in a male orientation.

FIG. 9B illustrates generally a pressure enhancement member 502 that is for connection to the pressure cuff 120 (not shown) by way of rail engagement members 504. In this embodiment, the rail engagement members 504 are in a female orientation.

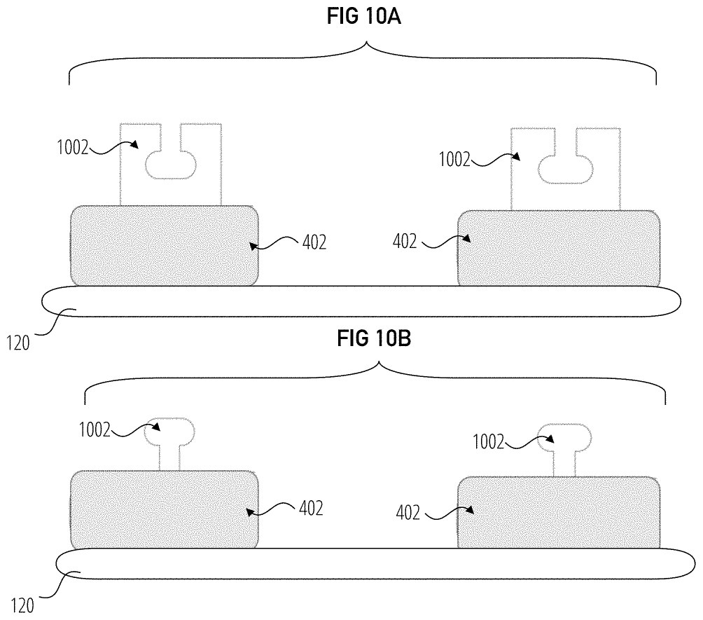

FIGS. 10A and 10B show in details of the connection mechanism of the rails 402 to the pressure enhancement members 502 (not shown).

FIG. 10A illustrates generally two rails 402 each having a pressure enhancement engagement member 1002 that is for connection to the pressure enhancement member 502 (not shown). In this embodiment, the pressure enhancement engagement members 1002 are in a female orientation.

FIG. 10B illustrates generally two rails 402 each having a pressure enhancement engagement member 1002 that is for connection to the pressure enhancement member 502 (not shown). In this embodiment, the pressure enhancement engagement members 1002 are in a male orientation.

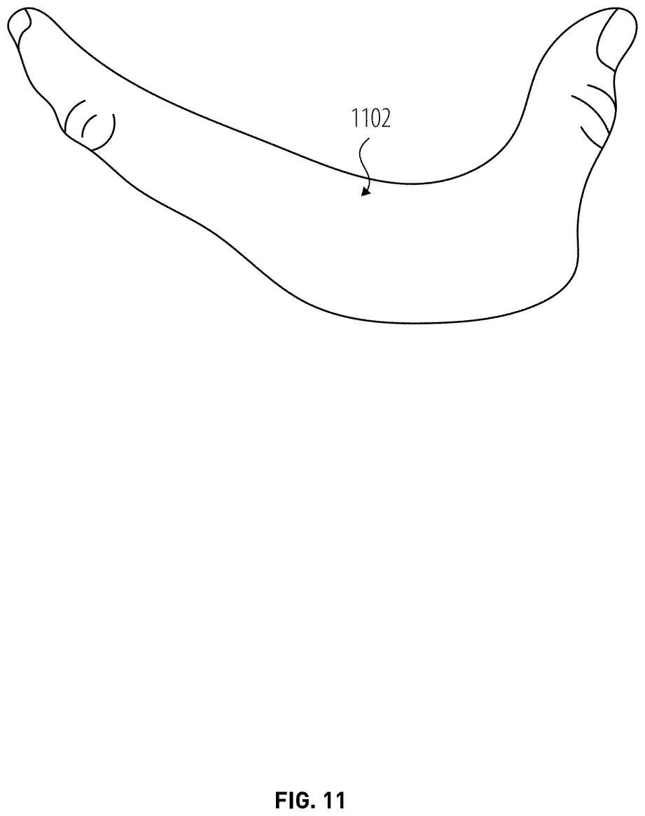

FIG. 11 shows a molded choking hand simulator 1102 that can be mounted on rails 402 (not shown) the inside of a pressure cuff 120 (also not shown). The molded choking hand simulator 1102 can be made from various different materials that are flexible such as silicone or rubber. The pressure enhancement member 502 that has the hand shaped attachment fitted to the one or more rails 402 that would simulate the feeling of being choked by a partner hand. This attachment would be important if audio were to be added to devices. Having the unit say something about choking you and then having the sensation of a real hand would be important to many users.

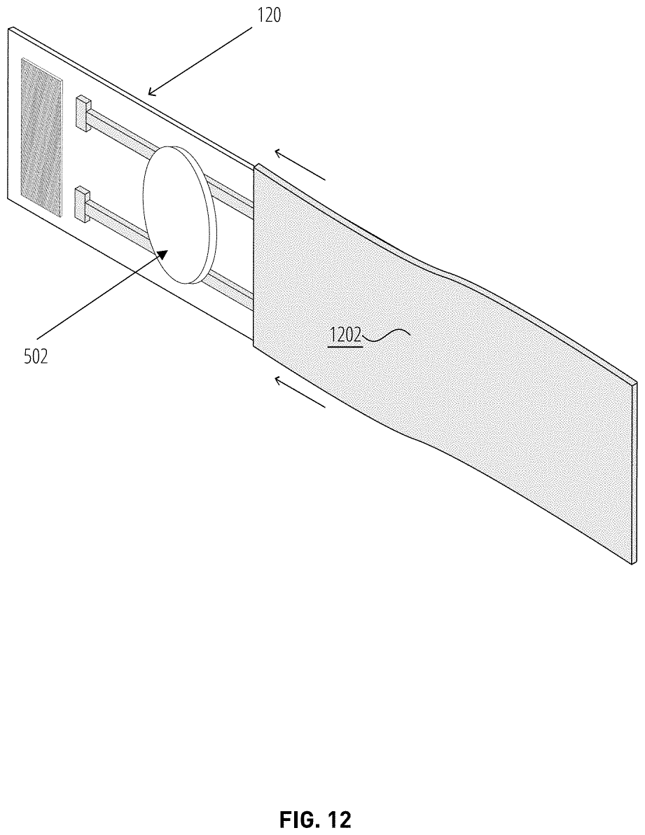

FIG. 12 shows an embodiment of a sleeve embodiment of the invention. The sleeve 1202 is configured as a tube of material the with two open ends.

The sleeve 1202 can be slide over the basic pressure cuff 120, that does not have one or more rails 402 or pressure enhancement members 502. In this instance, the sleeve 1202 could provide a variety of different customized exterior colors, fabrics, and textures. In some instances, studs may be present on a surface of the sleeve, to provide optional add-on features for the user.

In an alternative embodiment of the invention, the sleeve 1202 can be slide over the pressure cuff 120, and any pressure enhancement member 502 that is present. The customizable sleeve when slid over the pressure cuff 120, rails 402, and pressure enhancement members 502 may provide a more comfortable feel to the user. A great deal of pressure will be pushing against the neck of the user and exposed rails could cause discomfort to users who aren't looking for a pain aspect.

Embodiments of the invention may include commercial kits comprising the pressure cuff 120, combination pump and monitor unit 802, and one or more interchangeable sleeves 1202. In some embodiments, the pressure cuff 120 may also be fitted with rails 402 and one or more pressure enhancement members 502.

As described and illustrated above, numerous embodiments of the invention are contemplated to fall within the scope of protection being sought.

Humans will always engage in high-risk behavior and participants can engage in autoerotic asphyxiation using the disclosed pressure cuff 120 and combination pump and monitor unit 802 without accidentally suffocating to death. The timed pressure safety release function, or Dead man's switch, provides the safety aspects to allow participants to engage in AEA.

The design of the pressure cuff 120 is sleek, comfortable and adjustable and available in different sizes. The pressure cuff 120 can be fabricated in various colors and textures could be specifically customizable by the participant. Different internal attachments can be added by the participant. The attachments can be of any shape and size. They can be smooth or studded. They can be like the oval or round ball attachments illustrated in FIGS. 5, 6 and 7 as pressure enhancement members 502. Alternatively, they can mimic a choking hand by way of a hand-shaped simulator attachment illustrated in FIG. 11

The combination pump and monitor unit 802 is part of the device is of the type known to those of skill in the field. The technology resembles the monitor/pump device employed to inflate blood pressure cuffs except that it is modified to allow the pressure cuff 120 to remain inflated beyond an initial pre-determined time period and incorporates the manual and automatic deflation safety over-ride options. The combination pump and monitor unit 802 typically has a USB charger port.

The pressure cuff 120 and combination pump and monitor unit 802 can additionally be linked to a variety of hands-free devices, such as Siri® and Alexa®. These Safe-Phyx™ devices will allow participants to speak to the device to start or stop inflation. This feature will benefit visually impaired participants. Some participants may enjoy having the device speak to them. Certain may enhance the experience. Certain embodiments could feature the voices of popular actors or actresses. The pressure cuff 120 and combination pump and monitor unit 802 can also be controlled via cell phones, mobile devices, Bluetooth connections or other apps.

In some embodiments of the invention, the pressure cuff 120 has built-in optical sensors to provide the combination pump and monitor unit 802 with information relating to the participants current physiological condition and any pertinent changes in their physiology. There are several ways to measure and analyze blood flow. Photoplethysmography (PPG) is a non-invasive and simple technique that accesses capillaries using differential light absorption characteristics and an optical sensor. PPG detects changes in the pulse waves generated by blood flow through the microcirculation. When optical sensors are present in the pressure cuff 120 immediate feedback to the participant concerning their current physiological condition and any pertinent changes in their physiology, including hypoxia, hypercarbia and alkalosis, can be provided. Again, certain ranges for specific criteria can be pre-programmed into the combination pump and monitor unit 802, and when these ranges are exceeded, the pressure cuff 120 can be prematurely deflated.

The pressure cuff 120 and combination pump and monitor unit 802 could optionally be further customized via connection to linked VR compatibilities connecting the device to a virtual reality headset. This combination could provide participants with the ultimate experience, allowing them to be immersed in any environment of their choosing, including being able to see the person or thing choking them. The devices would pair and allow a pre-recorded experience all while still having easy access to the safety controls.

The combination pump and monitor unit 802 is able to control other attachments in place of the neck cuff. For example, an additional embodiment of the invention relates to the attachment of an inflatable cock ring attachment in place of the pressure cuff 120. The attachment of controllable, inflatable cock rings can be used to increase sexual pleasure for men.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A pleasure enhancement neck choke device, said device comprising:
a pressure cuff comprising a rectangular sleeve of fabric, said cuff and fabric having a length proportioned to encompass a neck of a user, the cuff having a front surface, a rear surface, an upper edge, a lower edge, a first side, a second side, and pair of cooperating fasteners attached to said first side and said second side;
one or more rails attached to said rear surface of the cuff, extending along the length of the cuff;
an air bladder installed in said sleeve, said air bladder positioned to apply pressure to arteries either side of the neck, the bladder attached to an inflation tube;
a combination pump and monitor unit in fluid communication with both of said air bladder and said inflation tube, said unit having a display screen; and
a timed safety release function and manual override feature comprising a series of controls on said monitor unit, one of said series of controls being programmable to inflate said air bladder to a selected pressure, one of said series of controls being programmable to maintain said selected pressure for a selected time period, one of said series of controls being programmable to allow manual extension of said selected time period in selected increments, one of said series of controls facilitating manual deflation of said air bladder, said unit being pre-programmed with certain safe maximum pressure levels and maximum time period for inflation,
wherein, when said maximum pre-programmed safe level for pressure or maximum pre-programmed safe time period for inflation have been exceeded, or if said one of said series of controls facilitating manual deflation is activated, said unit will automatically deflate said air bladder in said pressure cuff.

2. The device of claim 1, wherein said pair of cooperating fasteners attached to said first side and said second side of said pressure cuff are hook and loop fasteners.

3. The device of claim 1, wherein said pressure cuff has a decorative element releasably attached to said front surface.

4. The device of claim 3, wherein said decorative element is attached by snap fasteners or hook and loop fasteners.

5. The device of claim 1, wherein said pressure cuff has one or more embellishments permanently attached to said front surface or said rear surface.

6. The device of claim 5, wherein said one or more embellishments are studs or spikes.

7. (canceled)

8. The device of claim 1, wherein said one or more rails have end stops.

9. The device of claim 1, further comprising one or more pressure enhancement members configured to attach to said one or more rails.

10. The device of claim 9, wherein said one or more pressure enhancement members are round, oval or molded into the shape of a choking hand attachment.

11. The device of claim 1, wherein said front surface and said rear surface is fabricated from the group consisting of: silk; satin; cotton; and polyester.

12. The device of claim 1, wherein an additional sleeve of fabric is sized and proportioned to fit around said pressure cuff, said fabric optionally being customized or embellished.

13. The device of claim 1, wherein said combination pump and monitor unit is linked to a hands-free device.

14. The device of claim 1, wherein said combination pump and monitor unit is linked to a mobile device, cell phone, or Bluetooth connection.

15. The device of claim 1, wherein said combination pump and monitor unit is linked to a virtual reality (VR) headset.

16. The device of claim 1, wherein said pressure cuff has built-in optical sensors to provide real-time data relating to blood flow, oxygen levels, blood pressure, and hypoxia, to said combination pump and monitor unit for display on said screen.

17. A kit for creating a pleasure enhancement neck choke cuff, said kit comprising:
a pressure cuff comprising a rectangular sleeve of fabric, said cuff and fabric having a length proportioned to encompass a neck of a user, the cuff having a front surface, a rear surface, an upper edge, a lower edge, a first side, a second side, and pair of cooperating fasteners attached to said first side and said second side;
one or more rails attached to said rear surface of the cuff, extending along the length of the cuff;
an air bladder installed in said sleeve, said air bladder positioned to apply pressure to arteries either side of the neck, the bladder attached to an inflation tube;
a combination pump and monitor unit in fluid communication with both of said air bladder and said inflation tube, said unit having a display screen;
a timed safety release function and manual override feature comprising a series of controls on said monitor unit, one of said series of controls being programmable to inflate said air bladder to a selected pressure, one of said series of controls being programmable to maintain said selected pressure for a selected time period, one of said series of controls being programmable to allow manual extension of said selected time period in selected increments, one of said series of controls facilitating manual deflation of said air bladder, said unit being pre-programmed with certain safe maximum pressure levels and maximum time period for inflation; and
instructions for use,
wherein, when said maximum pre-programmed safe level for pressure or maximum pre-programmed safe time period for inflation have been exceeded, or if said one of said series of controls facilitating manual deflation is activated, said unit will automatically deflate said air bladder in said pressure cuff.

18. The kit of claim 17, further comprising decorative elements or embellishments to attach to said front surface or said rear surface.

19. The kit of claim 17, further comprising one or more pressure enhancement members adapted to attach to said one or more rails.

20. The kit of claim 17, further comprising an additional sleeve of fabric sized and proportioned to fit around said pressure cuff.

21. The kit of claim 19, wherein said one or more pressure enhancement members are selected from the group consisting of: circular; oval; or an attachment molded into the shape of a choking hand.
